(19) United States
(12) Patent Application Publication
(10) Pub. No.: US 2025/0185803 A1
(43) Pub. Date: Jun. 12, 2025

(54) FRAME STRUCTURE

(71) Applicant: Boyi WU, Fujian (CN)

(72) Inventor: Boyi WU, Fujian (CN)

(21) Appl. No.: 19/060,807

(22) Filed: Feb. 24, 2025

(30) Foreign Application Priority Data
Feb. 27, 2024 (CN) 202420362770X

(51) Int. Cl. A47B 47/00; A47B 57/54; A47B 96/06

(52) U.S. Cl. CPC A47B 47/0083; A47B 57/54; A47B 96/066

(57) ABSTRACT

A frame structure having at least one shelf board and some supporting rods; each shelf board has connectors at the corners, and each supporting rod has a connecting sleeve corresponding to a respective connector of a respective shelf board. Each connecting sleeve sleeves a corresponding supporting rod through a sleeve hole; a locking member is provided through an outer wall of each connecting sleeve. Each connector has a connecting clamping plate provided with a slot that opens towards a bottom end; the locking member transversely penetrates through the slot, and the slot allows the connecting clamping plate to be vertically slidable with respect to the locking member; and the connecting clamping plate is prevented from horizontal displacement by an anti-detachment part of the locking member. Accordingly, the frame structure is easy to assemble and disassemble.

### BACKGROUND OF THE INVENTION

The present invention relates to the technical field of frames for storage shelves or racks, particularly to a frame structure.

A storage rack, commonly used for storing goods, is widely used for stocking goods and storing parcels such as in supermarkets, warehouses, and courier points. Common storage racks include but not limited to wire racks and angle steel racks. For example, CN2263478Y discloses a storage device, which comprises a plurality of support rods and a plurality of shelf boards. Each of the shelf boards are provided integrally with trumpet-shaped sleeves which enable adjustable connection between the shelf board and corresponding support rods through cooperative configurations with corresponding fitting elements. However, because the trumpet-shaped sleeves are integrally disposed on each of the shelf boards, the corresponding support rods of each of the shelf boards have to be precisely positioned with respect to one another during assembly of the storage device, otherwise, the trumpet-shaped sleeves cannot be smoothly fitted onto the corresponding support rods. Accordingly, this prior art storage device is difficult to be assembled and disassembled, and the difficulty is heightened when taller support rods are used because a corresponding shelf board and its trumpet-shaped sleeves are even more difficult to fit onto the respective support rods from a taller height.

### BRIEF SUMMARY OF THE INVENTION

It is an object of the present invention to provide a frame structure which is easy to assemble and disassemble.

To attain the above object, the present invention provides the following technical solutions:

A frame structure, comprising at least one shelf board and a plurality of support rods; the plurality of support rods support said at least one shelf board;
each of said at least one shelf board is provided with a plurality of connectors corresponding to the plurality of support rods respectively, and the plurality of support rods are each provided with a connecting sleeve for each of said at least one shelf board, and the connecting sleeve is detachably connected with a respective one of the plurality of connectors;
the connecting sleeve is provided with a sleeve hole that penetrates a top end and a bottom end of the connecting sleeve; the sleeve hole is a tapered hole that gradually widens from the top end towards the bottom end of the connecting sleeve; the connecting sleeve is fitted onto a respective one of the plurality of support rods through the sleeve hole; at least one locking member is provided through an outer wall of the connecting sleeve, and an outer end, distal from the connecting sleeve, of each of said at least one locking member is provided with an anti-detachment part;
one side of each of the plurality of connectors is connected to a respective one of said at least one shelf board, another side of each of the plurality of connectors is provided with a connecting clamping plate; the connecting clamping plate is provided with a slot that opens towards a bottom end of the connecting clamping plate; said at least one locking member transversely penetrates through the slot, and the slot allows the connecting clamping plate to be vertically slidable with respect to said at least one locking member; and the connecting clamping plate is prevented from horizontal displacement by the anti-detachment part of each of said at least one locking member.

A plurality of annular slots are formed around an outer wall of each of the support rods and spaced apart vertically from one another along an axial direction of each of the support rods; each of the support rods is further provided with a fitting assembly corresponding to the connecting sleeve; the fitting assembly comprises two semi-sleeve bodies that are removably engaged with each other; an inner wall of the fitting assembly removably fits against the outer wall of a respective support rod, and the inner wall of the fitting assembly is also provided with an annular rib protruded from the inner wall of the fitting assembly; the annular rib is selectively engageable with one of the plurality of annular slots; an outer wall of the fitting assembly is a tapered wall that fits with the sleeve hole of the connecting sleeve.

Said plurality of support rods comprise four support rods; correspondingly, there are four connecting sleeves and four fitting assemblies for each of said at least one shelf board; said at least one shelf board comprises more than one shelf board vertically spaced apart from one another along the axial direction of each of the plurality of support rods, such that a total number of connecting sleeves in the frame structure is any multiple of four and a total number of fitting assemblies in the frame structure is also any multiple of four.

A horizontal cross-section of the sleeve hole is circular, elliptical, triangular, or rectangular; the outer wall of the connecting sleeve has a cylindrical profile, a frustum profile, or a prismatic profile.

Said at least one locking member is detachably connected through the outer wall of the connecting sleeve, or integrally welded to the connecting sleeve; the plurality of connectors are detachably connected or integrally welded to each of said at least one shelf board.

Each of said at least one locking member is a connecting screw, which is detachably screwed into a corresponding sleeve wall hole formed on the outer wall of the connecting sleeve; a screw head of the connecting screw serves as said anti-detachment part.

Four sleeve wall holes are circumferentially and evenly formed around the outer wall of the connecting sleeve.

Said one side of each of the plurality of connectors connected to the respective one of said at least one shelf board is defined as a connecting part; the connecting part is provided with connecting through-holes; the connecting part is detachably connected to the respective one of said at least one shelf board by fixing screws; the connecting clamping plate is provided with a concaved surface adapted to fit the outer wall of the connecting sleeve; the connecting part is located on top of the connecting clamping plate, or the connecting part is spaced apart horizontally from the connecting clamping plate; an accommodating space is provided on one surface of the connecting clamping plate facing away from the connecting sleeve.

A notch is formed at each of four corners of each of said at least one shelf board such that a respective one of the plurality of connectors is connected to the notch.

The connecting sleeve has an assembled structure; the connecting sleeve is divided into a first arc piece and a second arc piece along a radial direction thereof; the first arc piece and the second arc piece are detachably connected with each other to form the sleeve hole.

Each of two connecting surfaces at two ends of the first arc piece connecting to the second arc piece is opened with at least one connecting lock hole that penetrates through an outer circumferential surface of the first arc piece; each of two connecting surfaces at two ends of the second arc piece connecting to the first arc piece is opened with at least one connecting lock hole that penetrates through an outer circumferential surface of the second arc piece; when the first arc piece and the second arc piece are connected, said at least one connecting lock hole of each of two connecting surfaces at two ends of the first arc piece aligns with corresponding said at least one connecting lock hole of a corresponding connecting surface of a corresponding end of the second arc piece; a locking screw is removably inserted into each pair of aligned connecting lock holes to securely lock the first arc piece and the second arc piece.

One of two connecting end surfaces of two ends of the first arc piece connecting to the second arc piece is provided with at least one lock block protruding along a circumferential direction of the connecting sleeve; another one of the two connecting end surfaces of two ends of the first arc piece connecting to the second arc piece is provided with at least one lock slot recessed along the circumferential direction of the connecting sleeve; one of two connecting end surfaces of two ends of the second arc piece connecting to the first arc piece is provided with at least one lock block protruding along the circumferential direction of the connecting sleeve, and wherein said one of two connecting end surfaces of two ends of the second arc piece corresponds and faces towards said another one of the two connecting end surfaces of two ends of the first arc piece; another one of the two connecting end surfaces of two ends of the second arc piece connecting to the first arc piece is provided with at least one lock slot recessed along the circumferential direction of the connecting sleeve, and wherein said another one of the two connecting end surfaces of two ends of the second arc piece corresponds and faces towards said one of the two connecting end surfaces of two ends of the first arc piece; at least one axial end surface of each of the first arc piece and the second arc piece is provided with a locking through-hole that axially communicates with a corresponding one of said at least one lock slot formed on a respective arc piece; when the first arc piece and the second arc piece are connected, said at least one lock block of the first arc piece is inserted correspondingly into said at least one lock slot of the second arc piece, and the said at least one lock block of the second arc piece is inserted correspondingly into said at least one lock slot of the first arc piece; each of said at least one lock block of each of the first arc piece and the second arc piece is provided with a locking bottom hole corresponding to a respective locking through-hole on a respective arc piece; locking screws are removably provided wherein each of the locking screws passes through a corresponding locking through-hole and inserts into a corresponding locking bottom hole.

At least one end surface of the connecting sleeve is provided with two semi-circular lock pieces to connect the first arc piece and the second arc piece; each of the two semi-circular lock pieces is formed by two connecting sections extending along a circumferential direction of the connecting sleeve; one of the connecting sections is in contact with an end surface of the first arc piece, and another one of the connecting sections is in contact with an end surface of the second arc piece; the two connecting sections are provided with two lock piece through-holes respectively; the end surface of the first arc piece and the end surface of the second arc piece are provided with arc piece lock holes respectively that correspond to the two lock piece through-holes respectively; fasteners are provided to pass through the two lock piece through-holes and being locked into the arc piece lock holes respectively, thus achieving locking each of the two semi-circular lock pieces with the first arc piece and the second arc piece.

According to the technical solutions given above, when assembling the frame structure of the present invention, it is only necessary to set up the plurality of support rods vertically and space the plurality of support rods apart from one another; a connecting sleeve is also pre-installed onto each of the plurality of support rods for each shelf board. After adjusting all the connecting sleeves to a same horizontal level, align the slot on the connecting clamping plate of each of the connectors with said at least one locking member provided through a corresponding connecting sleeve, and then slide down the connecting clamping plate so that said at least one locking member is fitted into the slot; accordingly, quick connection and fixation of a shelf board with the plurality of support rods are achieved, thereby facilitating complete and efficient assembly of the frame structure. The anti-detachment part can prevent a corresponding support rod from being detached from the shelf board along a horizontal direction.

### BRIEF DESCRIPTION OF THE DRAWINGS

FIG. 1 is a perspective view of Embodiment 1 of the present invention;

FIG. 2 is an exploded view of a partial structure of Embodiment 1 of the present invention;

FIG. 3 is a diagram of a partial structure of Embodiment 1 of the present invention;

FIG. 4 is a partial sectional view of Embodiment 1 of the present invention;

FIG. 5 is a perspective view of Embodiment 2 of the present invention;

FIG. 6 is a diagram of a partial structure of Embodiment 2 of the present invention;

FIG. 7 is an exploded view of a partial structure of Embodiment 2 of the present invention;

FIG. 8 is a perspective view of Embodiment 3 of the present invention;

FIG. 9 is a diagram of a partial structure of Embodiment 3 of the present invention;

FIG. 10 is an exploded view of a partial structure of Embodiment 3 of the present invention;

FIG. 11 is a schematic diagram of the use of a connecting sleeve according to Embodiment 4 of the present invention;

FIG. 12 is a schematic diagram of the use of a connecting sleeve according to Embodiment 5 of the present invention; and

FIG. 13 is a schematic diagram of the use of a connecting sleeve according to Embodiment 6 of the present invention.

Reference numerals: shelf board 1, notch 11, notch plane 111, support rod 2, annular slot 21, connector 3, connecting clamping plate 31, slot 311, limiting flange 312, accommodating space 313, concaved surface 314, connecting part 32, straight plate 321, connecting through-hole 322, fixing screw 33, connecting sleeve 4, sleeve hole 41, locking member 42, anti-detachment part 421, sleeve wall hole 43, first arc piece 44, second arc piece 45, end 46, connecting surface 461, outer circumferential surface 462, connecting lock hole 463, lock block 464, locking bottom hole 4641, lock slot 465, axial end surface 466, locking through-hole 4661, locking screw 47, semi-circular lock piece 48, connecting section 481, lock piece through-hole 482, arc piece lock hole 49, fastener 50, fitting assembly 5, semi-sleeve body 51, annular rib 52.

### DETAILED DESCRIPTION OF THE INVENTION

### Embodiment 1

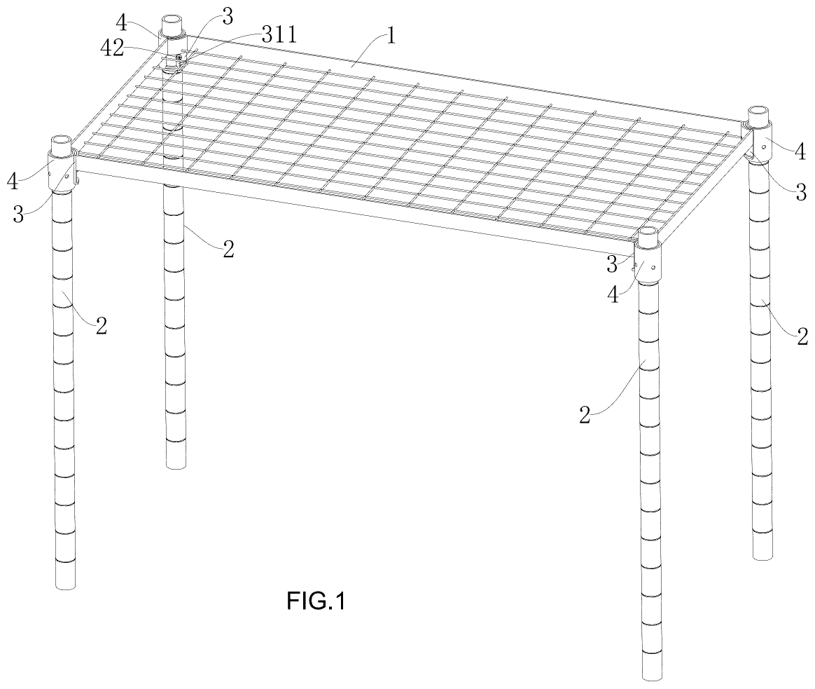

As shown in FIGS. 1 to 4, the present invention provides a frame structure, comprising a shelf board 1 and a plurality of support rods 2; the plurality of support rods 2 support the shelf board 1.

In this embodiment, said plurality of support rods 2 comprise four support rods 2 and one shelf board 1. Said shelf board 1 is embodied as a wire shelf board. The four support rods 2 are located at four corners of the shelf board 1 respectively.

The shelf board 1 is provided with a plurality of connectors 3 corresponding to the plurality of support rods 2 respectively, and the plurality of support rods 2 are each provided with a connecting sleeve 4, and the connecting sleeve 4 is detachably connected with a respective one of the plurality of connectors 3.

The connecting sleeve 4 is provided with a sleeve hole 41 that penetrates a top end and a bottom end of the connecting sleeve 4; the sleeve hole 41 is a tapered hole that gradually widens from the top end towards the bottom end of the connecting sleeve 4; the connecting sleeve 4 is fitted onto a respective one of the plurality of support rods 2 through the sleeve hole 41; at least one locking member 42 is provided through an outer wall of the connecting sleeve 4, and an outer end, distal from the connecting sleeve 4, of each locking member 42 is provided with an anti-detachment part 421.

One side of each of the plurality of connectors 3 is connected to the shelf board 1, another side of each of the plurality of connectors 3 is provided with a connecting clamping plate 31; the connecting clamping plate 31 is provided with a slot 311 that opens towards a bottom end of the connecting clamping plate 31; said at least one locking member 42 transversely penetrates through the slot 311, and the slot 311 allows the connecting clamping plate 31 to be vertically slidable with respect to said at least one locking member 42; and the connecting clamping plate 31 is prevented from horizontal displacement by the anti-detachment part 421 of each of said at least one locking member 42.

Accordingly, when assembling the frame structure of the present invention, it is only necessary to set up the plurality of support rods 2 vertically and space the plurality of support rods 2 apart from one another; a connecting sleeve 4 is also pre-installed onto each of the plurality of support rods 2. After adjusting all the connecting sleeves 4 to a same horizontal level, align the slot 311 on the connecting clamping plate 31 of each of the connectors 3 with said at least one locking member 42 provided through a corresponding connecting sleeve 4, and then slide down the connecting clamping plate 31 so that said at least one locking member 42 is fitted into the slot 311; accordingly, quick connection and fixation of the shelf board 1 with the plurality of support rods 2 are achieved, thereby facilitating complete and efficient assembly of the frame structure. The anti-detachment part 421 can prevent a corresponding support rod 2 from being detached from the shelf board 1 along a horizontal direction.

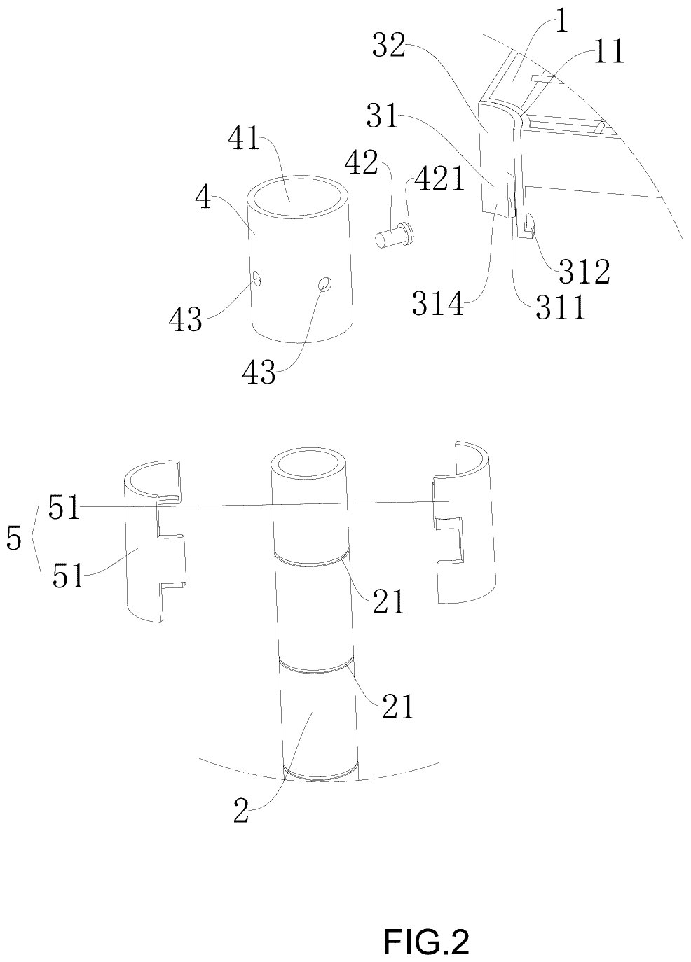

As shown in FIGS. 1 and 2, a plurality of annular slots 21 spaced apart vertically from one another are formed around an outer wall of each of the support rods 2; each of the support rods 2 is further provided with a fitting assembly 5 corresponding to the connecting sleeve; the fitting assembly 5 comprises two semi-sleeve bodies 51 that are removably engaged with each other; an inner wall of the fitting assembly 5 removably fits against the outer wall of a respective support rod 2, and the inner wall of the fitting assembly 5 is also provided with annular rib 52 protruded from the inner wall of the fitting assembly 5; the annular rib 52 is selectively engageable with one of the plurality of annular slots 21; an outer wall of the fitting assembly 5 is a tapered wall that fits with the sleeve hole 41 of the connecting sleeve 4.

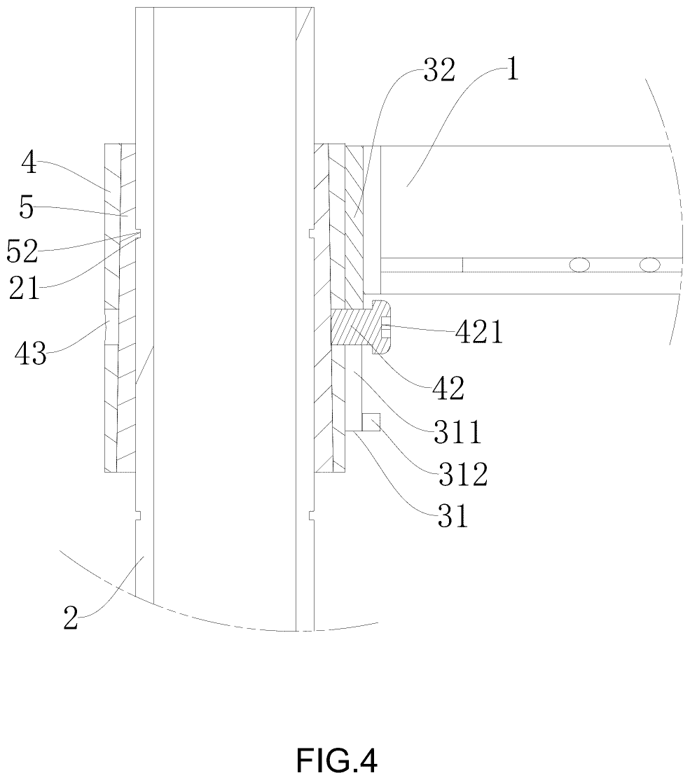

Accordingly, the two semi-sleeve bodies 51 engaged with each other are fitted on the support rod 2, and the annular rib 52 is aligned with a selected annular slot 21 of the support rod 2. Referring to FIG. 4, when the connecting sleeve 4 is fitted downwardly onto the support rod 2 and the fitting assembly 5 from a top end of the support rod, the tapered sleeve hole 41 of the connecting sleeve 4 will press against the fitting assembly 5 under the action of gravity or downward pressure, and this causes the outer wall of the fitting assembly 5 to be compressed and form a gripping force against the support rod 2, so that the fitting assembly 5 grips the support rod 2 more tightly as the connecting sleeve 4 is pressed downward. This provides an adjustable yet stable connection between the connecting sleeve 4 and the support rod 2.

By forming the plurality of annular slots 21 and using the fitting assembly 5, a position of the connecting sleeve 4 can be adjusted to different heights on the support rod 2, thereby adjusting the height of the shelf board 1.

In this embodiment, there are four connecting sleeves 4 and four fitting assemblies 5 in the frame structure. Of course, by utilizing the annular slots 21, more than one shelf board 1 may also be provided vertically spaced apart from one another, correspondingly, additional four connecting sleeves 4 and additional four fitting assemblies 5 may be configured in the same manner as described above for each additional shelf board 1.

Referring to FIG. 2, in this embodiment, a horizontal cross-section of the sleeve hole 41 is circular. Of course, the horizontal cross-section of the sleeve hole 41 may also be elliptical, triangular, square, rectangular, or the like, as long as it has a tapered structure that widens from the top end towards the bottom end of the connecting sleeve 4 so that the fitting assembly 5 can be compressed by a downward pressing force of the connecting sleeve 4 in order to grip the support rod 2.

In this embodiment, the outer wall of the connecting sleeve 4 has a cylindrical profile. Of course, the outer wall of the connecting sleeve 4 may also has a frustum or prismatic profile. The outer wall of the connecting sleeve 4 may have a profile that is the same as or different from a profile of the inner wall of the sleeve hole 41 since the profile of the outer wall of the connecting sleeve 4 will not affect the gripping effect of the tapered sleeve hole 41.

As shown in FIG. 2, in this embodiment, said at least one locking member 42 is detachably connected through the outer wall of the connecting sleeve 4.

Each of said at least one locking member 42 may be a connecting screw (external threads of the connecting screw omitted in the figure), which is detachably screwed into a corresponding sleeve wall hole 43 formed on the outer wall of the connecting sleeve 4. Internal threads can be formed within each sleeve wall hole 43; a screw head of the connecting screw serves as said anti-detachment part 421.

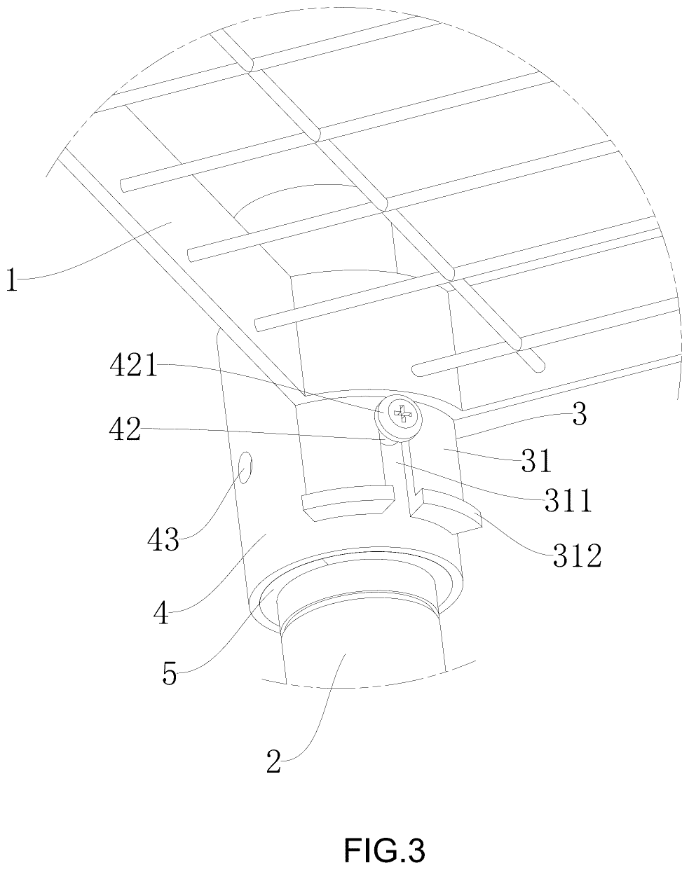

Referring further to FIGS. 3 and 4, since each of said at least one locking member 42 is said connecting screw, a limiting flange 312 extending towards a horizontal direction away from the connecting sleeve 4 can be provided at a lower edge of the connecting clamping plate 31. Since the limiting flange 312 protrudes from the lower edge of the connecting clamping plate 31, after the connecting clamping plate 31 slides down such that said at least one locking member 42 is fitted into the slot 311, the connecting screw (i.e. each of said at least one locking member 42) can be further screwed into the corresponding sleeve wall hole 43 (however maintaining the connecting screw to only penetrate through the outer wall of the sleeve 41 but not penetrating into the sleeve hole 41) such that the screw head i.e., the anti-detachment part 421 of the connecting screw is driven towards the connecting sleeve 4 so as to be positioned within an outer boundary delimited by the limiting flange 312. This allows the screw head of the connecting screw and the limiting flange 312 to be aligned along a same vertical plane, or the screw head of the connecting screw being located in vertical plane which is more proximal to the connecting sleeve 4 than a vertical plane where the limiting flange 312 is located, thereby preventing the connecting clamping plate 31 from being lifted up to an extent that the connecting clamping plate 31 is detached from said at least one locking member 42, thereby enhancing the overall stability of the frame structure.

In this embodiment, four sleeve wall holes 43 can be circumferentially and evenly formed around the outer wall of the connecting sleeve 4. Accordingly, the frame structure of the present invention can be further extended horizontally towards other sides by supplementing additional frame structure(s) according to the present invention, and adjacent additional frame structures can share a same support rod 2 and the connecting sleeve 4 thereon. Accordingly, the adjacent additional frame structures can be detachably connected with the initial frame structure, thereby enhancing the overall stability of the frame structure and making the frame structure more convenient for storing items.

Of course, said at least one locking member 42 may also be integrally welded to the connecting sleeve 4.

In this embodiment, the plurality of connectors 3 are integrally welded to the shelf board 1.

As shown in FIGS. 2 and 3, an upper portion of each of the plurality of connectors 3 connected to the shelf board 1 is defined as a connecting part 32; the connecting part 32 is integrally welded to the shelf board 1. The shelf board 1 is a wire shelf board, and a notch 11 can be formed at each of four corners of the wire shelf board such that a respective connecting part 32 is welded at the notch 11. The connecting part 32 is located on top of the connecting clamping plate 31, and the connecting clamping plate 31 is located below the connecting part 32.

Also, the connecting clamping plate 31 is provided with a concaved surface 314 adapted to fit the outer wall of the connecting sleeve 4. In this embodiment, the groove 314 is embodied as an arc-shaped concaved surface, and the concaved surface 314 can extend to the connecting part 32 to provide installation space for the connecting sleeve 4 and the support rod 2.

### Embodiment 2

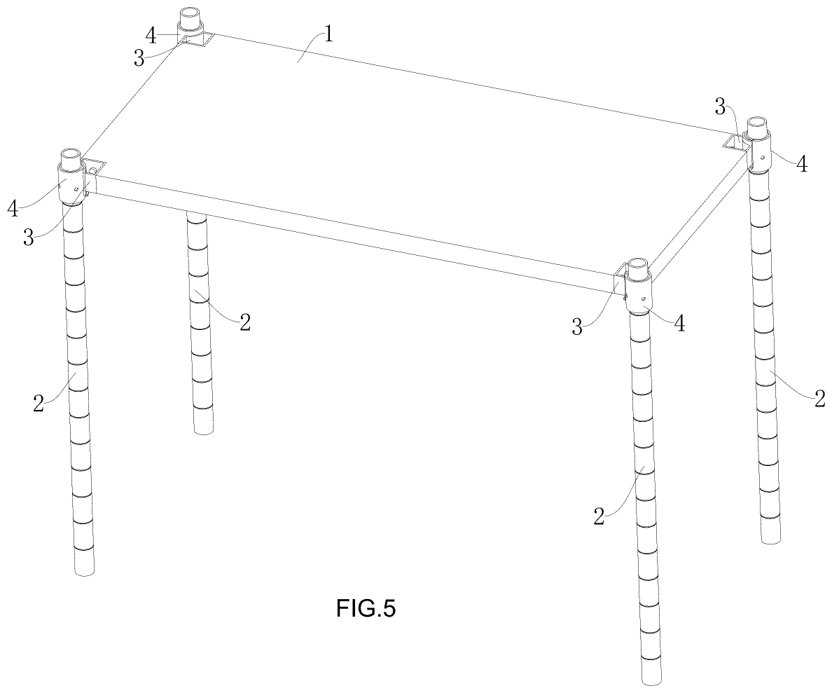

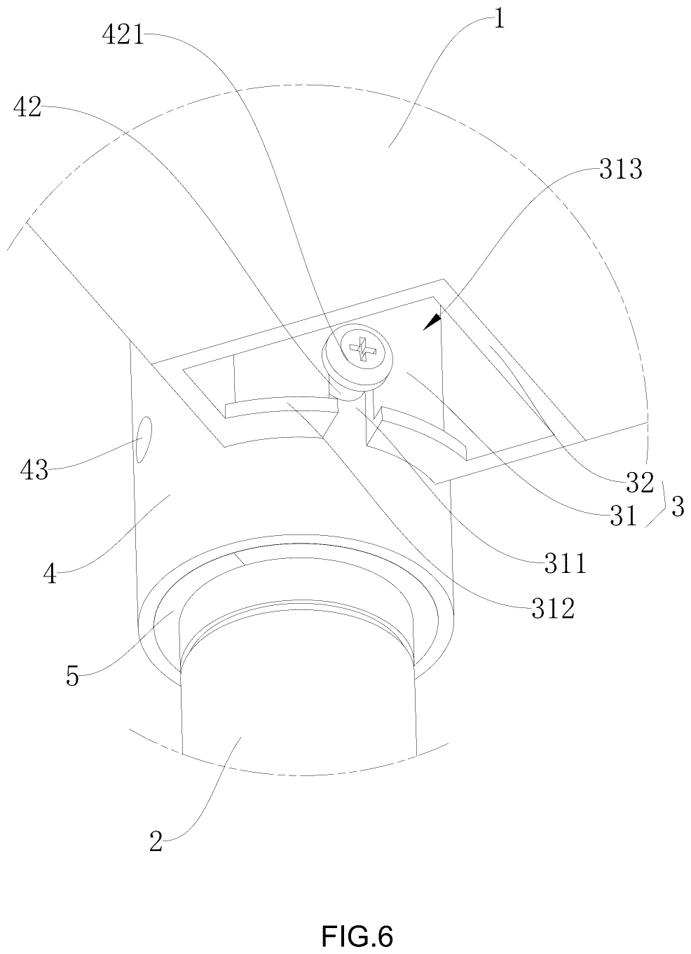

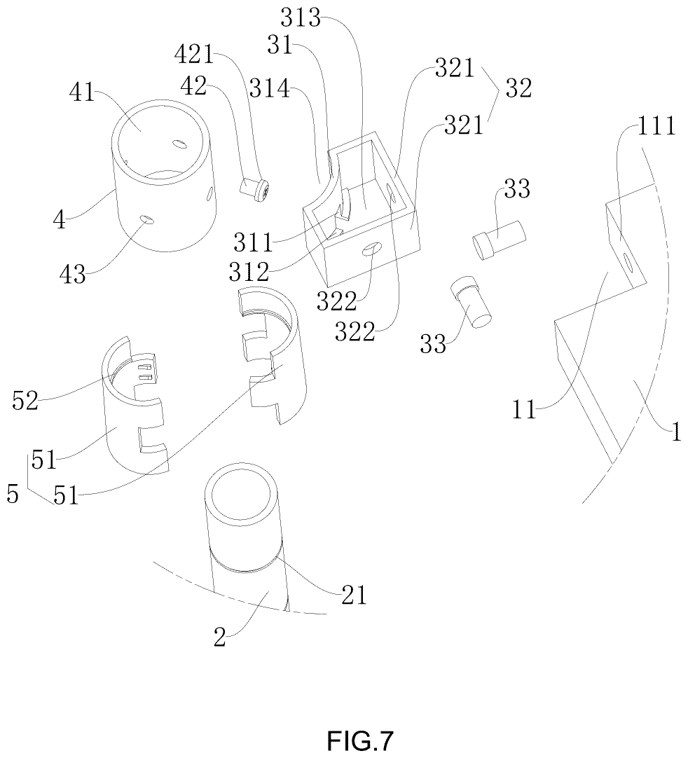

As shown in FIGS. 5 to 7, the structures of this embodiment are essentially the same as those of Embodiment 1 described above. The main difference is that in this embodiment, said one side of each of the plurality of connectors 3 connected to the shelf board 1 is defined as a connecting part 32, and the connecting part 32 is spaced apart horizontally from the connecting clamping plate 31.

In this embodiment, the shelf board 1 may be a slab of a wooden board or an aluminum-plastic board. The notch 11 has a rectangular shape; the connecting part 32 is right-angled consisting of two straight plates 321; first ends of the two straight plates 321 are connected such that the two straight plates 321 are positioned perpendicularly, wherein a connecting edge of said first ends of the two straight plates 321 is oriented vertically.

Second ends of the two straight plates 321 opposite to the first ends thereof are connected to two ends of the connecting clamping plate 31 respectively. Similarly, connecting edges of said second ends of the two straight plates 321 with the two ends of the connecting clamping plate 31 are also oriented vertically. A space between the connecting part 32 and one surface of the connecting clamping plate 31 facing away from the connecting sleeve 4 is defined as an accommodating space 313; the accommodating space 313 provides a space to accommodate the locking member 42 of the connecting sleeve 4; a middle part of the connecting clamping plate 31 has an arc shape that fits the outer wall of the connecting sleeve 4.

The two straight plates 321 of the connecting part 32 are provided with two connecting through-holes 322 respectively; the two straight plates 321 are detachably connected to two notch planes 111 of the notch 11 by fixing screws 33. The fixing screws 33 perform connection of the two straight plates 321 to the two notch planes 111 by making use of the accommodating space 313.

Use of the connectors 3 allows for the convenient connection and fixation to the wooden board or aluminum-plastic board and facilitates the assembly of the shelf board 1 with the support rods 2 and the connecting sleeves 4.

### Embodiment 3

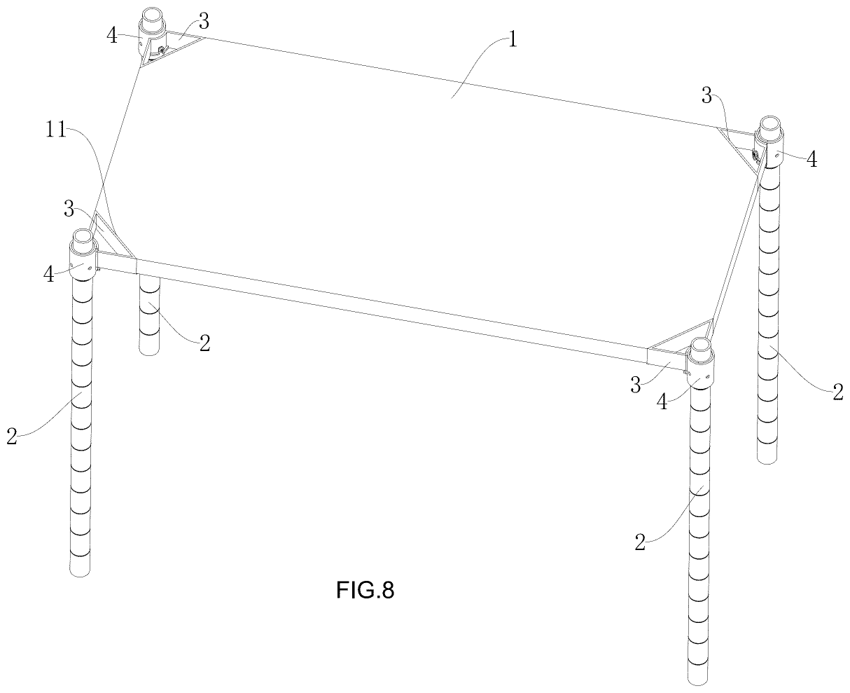

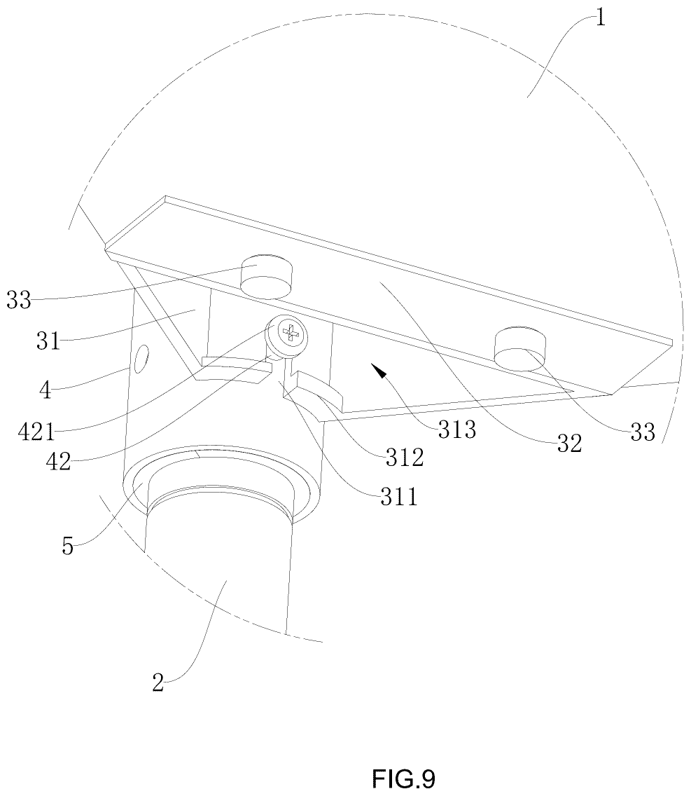

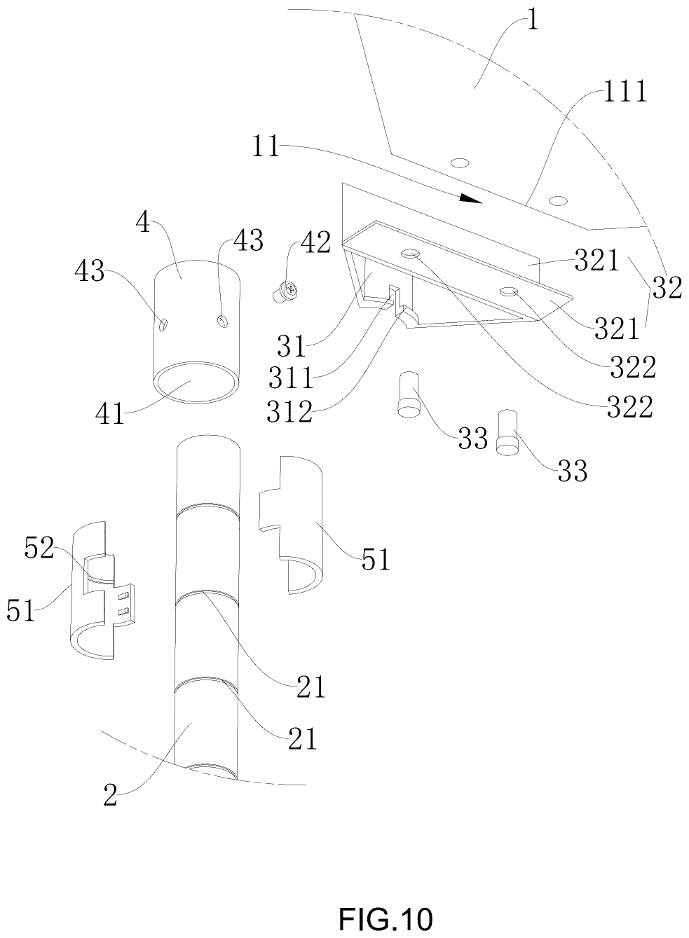

As shown in FIGS. 8 to 10, the structures of this embodiment are essentially the same as those of Embodiment 2. The main difference is that in this embodiment, the notch 11 has a right-angled triangular shape, wherein two sides adjacent a right-angle of the right-angled triangular shape are co-linear with two corresponding sides of the shelf board 1 respectively.

In this embodiment, the connecting part 32 is also right-angled consisting of two straight plates 321; first ends of the two straight plates 321 are connected such that the two straight plates 321 are positioned perpendicularly, wherein a connecting edge of the first ends of the two straight plates 321 is oriented horizontally.

Specifically, one of the two straight plates 321 that extends vertically has two vertically oriented lateral sides thereof connected to two vertically oriented lateral sides of the connecting clamping plate 31 respectively. Moreover, a surface of said one of the two straight plates 321 that extends vertically is in full contact with a notch plane 111 of the notch 11; another one of the two straight plates 321 that extends horizontally extends oppositely away from the connecting clamping plate 31; said another one of the two straight plates 321 that extends horizontally is provided with two connecting through-holes 322 spaced apart from each other; said another one of the two straight plates 321 that extends horizontally is detachably connected to a top or a bottom surface of a corresponding corner of the shelf board 1 by fixing screws 33.

A space between the connecting part 32 and one surface of the connecting clamping plate 31 facing away from the connecting sleeve 4 is defined as an accommodating space 313. The accommodating space 313 provides a space to accommodate the locking member 42 of the connecting sleeve 4.

In the embodiment, use of the connectors 3 of different structures compared with embodiment 2 can similarly allow for the convenient connection and fixation to the wooden board and facilitates the assembly of the shelf board 1 with the support rods 2 and the connecting sleeves 4.

### Embodiment 4

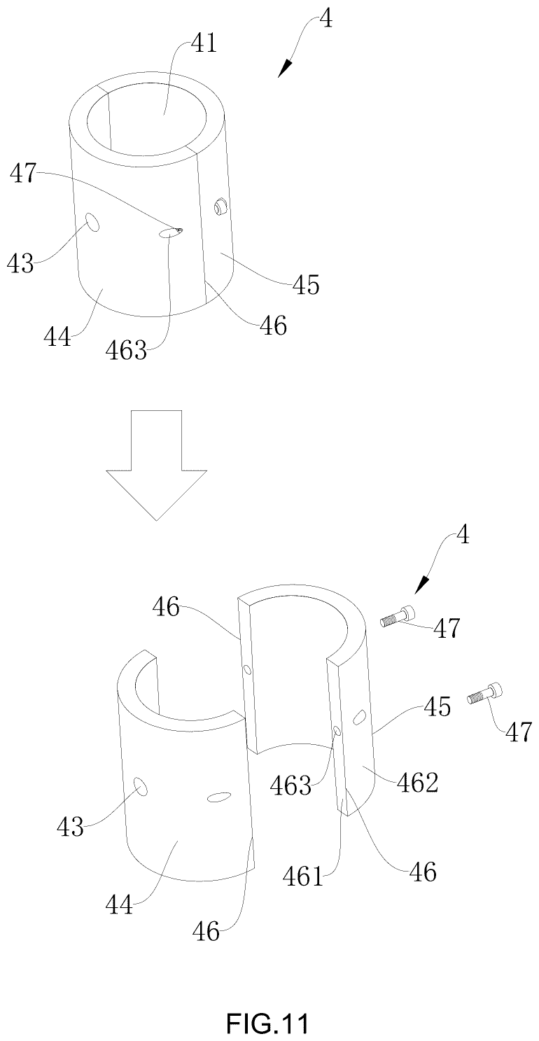

As shown in FIG. 11, the structures of this embodiment are essentially the same as those of Embodiment 1, and the main difference is that the connecting sleeve 4 has an assembled structure.

Specifically, the connecting sleeve 4 is divided into a first arc piece 44 and a second arc piece 45 along a radial direction thereof; the first arc piece 44 and the second arc piece 45 are detachably connected with each other. When connected with each other, the first arc piece 44 and the second arc piece 45 form the sleeve hole 41 of a cylindrical shape.

Each of two connecting surfaces 461 at two ends 46 of the first arc piece 44 connecting to the second arc piece 45 is opened with a connecting lock hole 463 that penetrates through an outer circumferential surface 462 of the first arc piece 44; similarly, each of two connecting surfaces 461 at two ends 46 of the second arc piece 45 connecting to the first arc piece 44 is opened with a connecting lock hole 463 that penetrates through an outer circumferential surface 462 of the second arc piece 45; when the first arc piece 44 and the second arc piece 45 are connected, the connecting lock hole 463 of each of two connecting surfaces 461 at two ends 46 of the first arc piece 44 aligns with a corresponding connecting lock hole 463 of a corresponding connecting surface 461 of a corresponding end 46 of the second arc piece 45; a locking screw 47 is inserted into each pair of aligned connecting lock holes 463 to securely lock the first arc piece 44 and the second arc piece 45.

Internal threads are formed in each connecting lock hole 463 on the first arc piece 44; each connecting lock hole 463 on the second arc piece 45 is a smooth hole with a countersink on one side proximal to the outer circumferential surface 462 of the second arc piece 45 to accommodate and limit a screw head of the locking screw 47 within the countersink. Moreover, this ensures a tighter connection between the first arc piece 44 and the second arc piece 45.

In the embodiment, the sleeve wall holes 43 of the connecting sleeve 4 can be formed on the first arc piece 44 and/or the second arc piece 45.

According to the above, the connecting sleeve 4 is allowed to be disassembled, such that when an additional shelf board 1 is required between two existing shelf boards 1 in the frame structure, it is not necessary to remove the shelf board 1 on the upper side. Instead, by simply dividing the connecting sleeve 4 into the first arc piece 44 and the second arc piece 45, and then engaging the first arc piece 44 and the second arc piece 45 around the two semi-sleeve bodies 51 of a corresponding support rod 2 respectively, and then inserting the locking screws 47, the connecting sleeve 4 can be connected to the corresponding support rod 2. Repeats the same procedures on all support rods 2, and subsequently by using the locking member 42 of each support rod 2, the additional shelf board 1 can be quickly connected to the frame structure, thereby completing the installation of the additional shelf board 1.

In this embodiment, each connecting lock hole 463 of each of the first arc piece 44 and the second arc piece 45 is formed in a middle part of a corresponding connecting surface 461. Of course, a plurality of connecting lock holes spaced apart from one another may be formed along a vertical direction of the corresponding connecting surface 461 to enhance the locking effect between the first arc piece 44 and the second arc piece 45.

### Embodiment 5

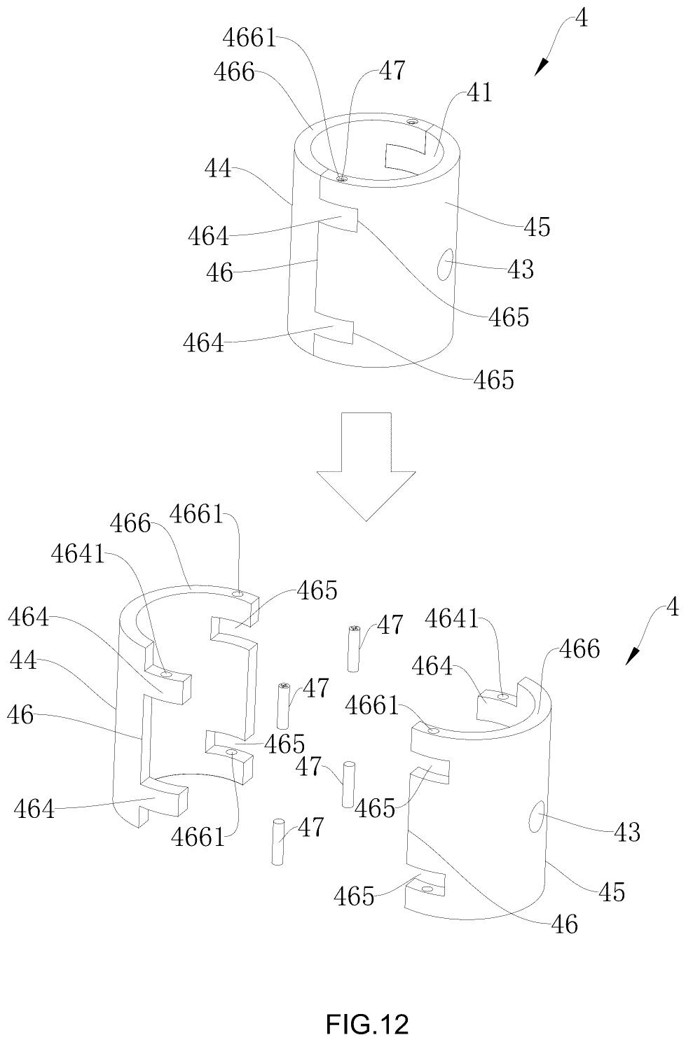

As shown in FIG. 12, the structures of this embodiment are essentially the same as those of Embodiment 1, and the main difference is that the connecting sleeve 4 has an assembled structure.

Specifically, the connecting sleeve 4 is divided into a first arc piece 44 and a second arc piece 45 along a radial direction thereof; the first arc piece 44 and the second arc piece 45 are detachably connected with each other. When connected with each other, the first arc piece 44 and the second arc piece 45 form the sleeve hole 41 of a cylindrical shape.

One of two connecting end surfaces of two ends 46 of the first arc piece 44 connecting to the second arc piece 45 is provided with two lock blocks 464 protruding along a circumferential direction of the connecting sleeve 4 and spaced apart from each other along an axial direction of the connecting sleeve 4; another one of the two connecting end surfaces of two ends 46 of the first arc piece 44 connecting to the second arc piece 45 is provided with lock slots 465 recessed along the circumferential direction of the connecting sleeve 4 and spaced apart from each other along the axial direction of the connecting sleeve 4; one of two connecting end surfaces of two ends 46 of the second arc piece 45 connecting to the first arc piece 44 is provided with two lock blocks 464 protruding along the circumferential direction of the connecting sleeve 4 and spaced apart from each other along the axial direction of the connecting sleeve 4, and wherein said one of two connecting end surfaces of two ends 46 of the second arc piece 44 corresponds and faces towards said another one of the two connecting end surfaces of two ends 46 of the first arc piece 44; another one of the two connecting end surfaces of two ends 46 of the second arc piece 45 connecting to the first arc piece 44 is provided with lock slots 465 recessed along the circumferential direction of the connecting sleeve 4 and spaced apart from each other along the axial direction of the connecting sleeve 4, and wherein said another one of the two connecting end surfaces of two ends 46 of the second arc piece 45 corresponds and faces towards said one of the two connecting end surfaces of two ends 46 of the first arc piece 44. Further, two axial end surfaces 466 of each of the first arc piece 44 and the second arc piece 45 are provided with two locking through-holes 4661 respectively that axially communicate with the lock slots 465 formed on a respective arc piece. When the first arc piece 44 and the second arc piece 45 are connected, the lock blocks 464 of the first arc piece 44 are inserted into the lock slots 465 of the second arc piece 45, and the lock blocks 464 of the second arc piece 45 are inserted into the lock slots 465 of the first arc piece 44. Additionally, each of the lock blocks 464 of each of the first arc piece 44 and the second arc piece 45 is provided with a locking bottom hole 4641 corresponding to a respective one of the locking through-holes 4661 on a respective arc piece. Four locking screws 47 are used wherein each of the four locking screws 47 passes through a corresponding one of the locking through-holes 4661 and inserts into a corresponding one of the locking bottom holes 4641, thereby achieving the connection of the first arc piece 44 and the second arc piece 45.

According to the above, the connecting sleeve 4 is allowed to be disassembled, such that when an additional shelf board 1 is required between two existing shelf boards 1 in the frame structure, it is not necessary to remove the shelf board 1 on the upper side. Instead, by simply dividing the connecting sleeve 4 into the first arc piece 44 and the second arc piece 45, and then engaging the first arc piece 44 and the second arc piece 45 around the two semi-sleeve bodies 51 of a corresponding support rod 2 respectively, and then inserting the locking screws 47, the connecting sleeve 4 can be connected to the corresponding support rod 2. Repeats the same procedures on all support rods 2, and subsequently by using the locking member 42 of each support rod 2, the additional shelf board 1 can be quickly connected to the frame structure, thereby completing the installation of the additional shelf board 1.

In this embodiment, each of two ends 46 of each of the first arc piece 44 and the second arc piece 45 is provided with two lock blocks 464 or two lock slots 465. Of course, it is also possible to provide only one lock slot 465 and one lock block 464, and correspondingly, only one locking through-hole 4661 can be provided on each of the first arc piece 44 and the second arc piece 45. This alternative configuration of this embodiment can also achieve the connection of the first arc piece 44 and the second arc piece 45.

### Embodiment 6

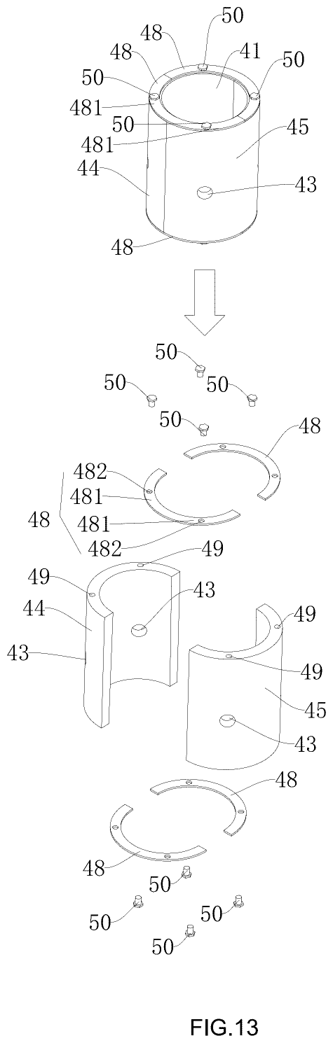

As shown in FIG. 13, the structures of this embodiment are essentially the same as those of Embodiment 1, and the main difference is that the connecting sleeve 4 has an assembled structure.

The connecting sleeve 4 is divided into a first arc piece 44 and a second arc piece 45 along a radial direction thereof. At least one end surface of the connecting sleeve 4 is provided with two semi-circular lock pieces 48 to connect the first arc piece 44 and second arc piece 45. The sleeve hole 41 is formed between the first arc piece 44 and the second arc piece 45.

Each of the two semi-circular lock pieces 48 is formed by two connecting sections 481 extending along a circumferential direction of the connecting sleeve 4; one of the connecting sections 481 is in contact with an end surface of the first arc piece 44, and another one of the connecting sections 481 is in contact with an end surface of the second arc piece 45. Further, the two connecting sections 481 are provided with two lock piece through-holes 482 respectively. The end surface of the first arc piece 44 and the end surface of the second arc piece 45 are provided with arc piece lock holes 49 respectively that correspond to the two lock piece through-holes 482 respectively. Fasteners 50 such as screws can pass through the two lock piece through-holes 482 and being locked into the arc piece lock holes 49 respectively, thus achieving locking each of the two semi-circular lock pieces 48 with the first arc piece 44 and the second arc piece 45.

By using two semi-circular lock pieces 48, one end surface of the first arc piece 44 and one corresponding end surface of the second arc piece 45 can be locked together. Each of two end surfaces of the connecting sleeve 4 may be provided with two semi-circular lock pieces 48, such that a total of four semi-circular lock pieces 48 are arranged on upper and lower end surfaces of the first arc piece 44 and the second arc piece 45. Accordingly, connection of the first arc piece 44 and the second arc piece 45 can be achieved to forming the connecting sleeve 4.

In this embodiment, the sleeve wall holes 43 of the connecting sleeve 4 can be formed on the first arc piece 44 and/or the second arc piece 45.

According to the above, the connecting sleeve 4 is allowed to be disassembled, such that when an additional shelf board 1 is required between two existing shelf boards 1 in the frame structure, it is not necessary to remove the shelf board 1 on the upper side. Instead, by simply dividing the connecting sleeve 4 into the first arc piece 44 and the second arc piece 45, and then engaging the first arc piece 44 and the second arc piece 45 around the two semi-sleeve bodies 51 of a corresponding support rod 2 respectively, and then locking four semi-circular lock pieces 48 on the upper and lower end surfaces of the first arc piece 44 an the second arc piece 45, the connecting sleeve 4 can be connected to the corresponding support rod 2. Repeats the same procedures on all support rods 2, and subsequently by using the locking member 42 of each support rod 2, the additional shelf board 1 can be quickly connected to the frame structure, thereby completing the installation of the additional shelf board 1.

What is claimed is:

1. A frame structure, comprising:
at least one shelf board and a plurality of support rods; the plurality of support rods support said at least one shelf board;
each of said at least one shelf board is provided with a plurality of connectors corresponding to the plurality of support rods respectively, and the plurality of support rods are each provided with a connecting sleeve for each of said at least one shelf board, and the connecting sleeve is detachably connected with a respective one of the plurality of connectors;
the connecting sleeve is provided with a sleeve hole that penetrates a top end and a bottom end of the connecting sleeve; the sleeve hole is a tapered hole that gradually widens from the top end towards the bottom end of the connecting sleeve; the connecting sleeve is fitted onto a respective one of the plurality of support rods through the sleeve hole; at least one locking member is provided through an outer wall of the connecting sleeve, and an outer end, distal from the connecting sleeve, of each of said at least one locking member is provided with an anti-detachment part;
one side of each of the plurality of connectors is connected to a respective one of said at least one shelf board, another side of each of the plurality of connectors is provided with a connecting clamping plate; the connecting clamping plate is provided with a slot that opens towards a bottom end of the connecting clamping plate; said at least one locking member transversely penetrates through the slot, and the slot allows the connecting clamping plate to be vertically slidable with respect to said at least one locking member; and the connecting clamping plate is prevented from horizontal displacement by the anti-detachment part of each of said at least one locking member.

2. The frame structure of claim 1, wherein a plurality of annular slots are formed around an outer wall of each of the support rods and spaced apart vertically from one another along an axial direction of each of the support rods; each of the support rods is further provided with a fitting assembly corresponding to the connecting sleeve; the fitting assembly comprises two semi-sleeve bodies that are removably engaged with each other; an inner wall of the fitting assembly removably fits against the outer wall of a respective support rod, and the inner wall of the fitting assembly is also provided with an annular rib protruded from the inner wall of the fitting assembly; the annular rib is selectively engageable with one of the plurality of annular slots; an outer wall of the fitting assembly is a tapered wall that fits with the sleeve hole of the connecting sleeve.

3. The frame structure of claim 2, wherein said plurality of support rods comprise four support rods; correspondingly, there are four connecting sleeves and four fitting assemblies for each of said at least one shelf board.

4. The frame structure of claim 1, wherein a horizontal cross-section of the sleeve hole is circular; the outer wall of the connecting sleeve has a cylindrical profile.

5. The frame structure of claim 1, wherein said at least one locking member is detachably connected through the outer wall of the connecting sleeve, or integrally welded to the connecting sleeve; the plurality of connectors are detachably connected or integrally welded to each of said at least one shelf board.

6. The frame structure of claim 5, wherein each of said at least one locking member is a connecting screw, which is detachably screwed into a corresponding sleeve wall hole formed on the outer wall of the connecting sleeve; a screw head of the connecting screw serves as said anti-detachment part.

7. The frame structure of claim 6, wherein four sleeve wall holes are circumferentially and evenly formed around the outer wall of the connecting sleeve.

8. The frame structure of claim 5, wherein said one side of each of the plurality of connectors connected to the respective one of said at least one shelf board is defined as a connecting part; the connecting part is provided with connecting through-holes; the connecting part is detachably connected to the respective one of said at least one shelf board by fixing screws; the connecting clamping plate is provided with a concaved surface adapted to fit the outer wall of the connecting sleeve; the connecting part is spaced apart horizontally from the connecting clamping plate; an accommodating space is provided on one surface of the connecting clamping plate facing away from the connecting sleeve.

9. The frame structure of claim 5, wherein a notch is formed at each of four corners of each of said at least one shelf board such that a respective one of the plurality of connectors is connected to the notch.

10. The frame structure of claim 1, wherein the connecting sleeve has an assembled structure; the connecting sleeve is divided into a first arc piece and a second arc piece along a radial direction thereof; the first arc piece and the second arc piece are detachably connected with each other to form the sleeve hole.

11. The frame structure of claim 10, wherein each of two connecting surfaces at two ends of the first arc piece connecting to the second arc piece is opened with at least one connecting lock hole that penetrates through an outer circumferential surface of the first arc piece; each of two connecting surfaces at two ends of the second arc piece connecting to the first arc piece is opened with at least one connecting lock hole that penetrates through an outer circumferential surface of the second arc piece; when the first arc piece and the second arc piece are connected, said at least one connecting lock hole of each of two connecting surfaces at two ends of the first arc piece aligns with corresponding said at least one connecting lock hole of a corresponding connecting surface of a corresponding end of the second arc piece; a locking screw is removably inserted into each pair of aligned connecting lock holes to securely lock the first arc piece and the second arc piece.

12. The frame structure of claim 10, wherein one of two connecting end surfaces of two ends of the first arc piece connecting to the second arc piece is provided with at least one lock block protruding along a circumferential direction of the connecting sleeve; another one of the two connecting end surfaces of two ends of the first arc piece connecting to the second arc piece is provided with at least one lock slot recessed along the circumferential direction of the connecting sleeve; one of two connecting end surfaces of two ends of the second arc piece connecting to the first arc piece is provided with at least one lock block protruding along the circumferential direction of the connecting sleeve, and wherein said one of two connecting end surfaces of two ends of the second arc piece corresponds and faces towards said another one of the two connecting end surfaces of two ends of the first arc piece; another one of the two connecting end surfaces of two ends of the second arc piece connecting to the first arc piece is provided with at least one lock slot recessed along the circumferential direction of the connecting sleeve, and wherein said another one of the two connecting end surfaces of two ends of the second arc piece corresponds and faces towards said one of the two connecting end surfaces of two ends of the first arc piece; at least one axial end surface of each of the first arc piece and the second arc piece is provided with a locking through-hole that axially communicates with a corresponding one of said at least one lock slot formed on a respective arc piece; when the first arc piece and the second arc piece are connected, said at least one lock block of the first arc piece is inserted correspondingly into said at least one lock slot of the second arc piece, and the said at least one lock block of the second arc piece is inserted correspondingly into said at least one lock slot of the first arc piece; each of said at least one lock block of each of the first arc piece and the second arc piece is provided with a locking bottom hole corresponding to a respective locking through-hole on a respective arc piece; locking screws are removably provided wherein each of the locking screws passes through a corresponding locking through-hole and inserts into a corresponding locking bottom hole.

13. The frame structure of claim 10, wherein at least one end surface of the connecting sleeve is provided with two semi-circular lock pieces to connect the first arc piece and the second arc piece; each of the two semi-circular lock pieces is formed by two connecting sections extending along a circumferential direction of the connecting sleeve; one of the connecting sections is in contact with an end surface of the first arc piece, and another one of the connecting sections is in contact with an end surface of the second arc piece; the two connecting sections are provided with two lock piece through-holes respectively; the end surface of the first arc piece and the end surface of the second arc piece are provided with arc piece lock holes respectively that correspond to the two lock piece through-holes respectively; fasteners are provided to pass through the two lock piece through-holes and being locked into the arc piece lock holes respectively, thus achieving locking each of the two semi-circular lock pieces with the first arc piece and the second arc piece.

14. The frame structure of claim 1, wherein an upper side of each of the plurality of connectors connected to the respective one the said at least one shelf board is defined as a connecting part; the connecting part is located on top of the connecting clamping plate, and the connecting clamping plate is located below the connecting part.
